(19) United States
(12) Patent Application Publication
(10) Pub. No.: US 2012/0075293 A1
(43) Pub. Date: Mar. 29, 2012

(54) ADJUSTMENT METHOD OF STEREOSCOPIC DISPLAY, ADJUSTMENT DEVICE USED THEREFORE, STEREOSCOPIC IMAGE DISPLAY METHOD, AND DISPLAY DEVICE USE THEREFORE

(75) Inventors: Takao KUWABARA, Ashigarakami-gun (JP); Wataru ITO, Ashigarakami-gun (JP); Masahiko YAMADA, Ashigarakami-gun (JP); Yasunori OHTA, Ashigarakami-gun (JP); Takeshi KAMIYA, Ashigarakami-gun (JP); Tetsuro KUSUNOKI, Ashigarakami-gun (JP)

(73) Assignee: FUJIFILM CORPORATION, Tokyo (JP)

(21) Appl. No.: 13/233,722

(22) Filed: Sep. 15, 2011

(30) Foreign Application Priority Data
Sep. 29, 2010 (JP) 2010-218319

(51) Int. Cl. G06T 15/00

(52) U.S. Cl. 345/419

(57) ABSTRACT

In an adjustment method of a stereoscopic display used for stereoscopic display and an adjustment device used therefore, the burden on an observer can be reduced. An adjustment method of a stereoscopic display having a light output unit for a right eye which outputs a light signal for the right eye and a light output unit for a left eye which outputs a light signal for the left eye includes: performing first measurement for measuring the luminance of the light signal for the right eye; performing second measurement for measuring the luminance of the light signal for the left eye; acquiring first and second representative luminance values corresponding to each other by the first and second measurements, respectively; and adjusting an output of the light output unit such that a difference between the first and second representative luminance values falls within a predetermined range.

### BACKGROUND OF THE INVENTION

1. Field of the Invention

The present invention relates to an adjustment method of a stereoscopic display used when displaying a stereoscopic image, which includes an image for the right eye and an image for the left eye with parallax on which a subject is captured, for stereoscopic viewing, an adjustment device used therefore, a stereoscopic image display method of displaying a stereoscopic image, and a display device used therefore.

2. Description of the Related Art

In the related art, realizing stereoscopic viewing based on an image formed by a pair of images, that is, an image for the right eye and an image for the left eye with parallax (called a stereoscopic image or a stereo image) is known. Such a stereoscopic image is generated based on a plurality of images with parallax acquired by radiographing the same subject from different directions. Through stereoscopic viewing, an observer can recognize a stereoscopic image as a three-dimensional image as a result of mixing of two images with parallax in the brain. Accordingly, in order to facilitate the mixing in the brain smoothly, it is important that two images which form a stereoscopic image harmonize with each other in terms of brightness, color, and the like.

Such a stereoscopic image is used not only in the field of digital cameras, televisions, or the like but also in the field of radiological image radiographing systems or endoscope systems.

For example, such a radiological image radiographing system radiates radiation for a subject from different directions, detects radiation transmitted through the subject using a radiological image detector to acquire a plurality of radiological images with parallax, and generates a stereoscopic image based on the radiological images. Since a radiological image can be observed with a sense of depth by generating a stereoscopic image as described above, a radiological image more suitable for diagnosis can be observed.

Moreover, for example, as disclosed in JP1998-221637A (JP-H10-221637A), such a stereoscopic endoscope system captures left and right images with parallax of a part to be observed using a stereoscopic endoscope having a two-lens observation optical system and an imaging device, and generates a stereoscopic image using image signals of the left and right images from the stereoscopic endoscope.

The observer can recognize the stereoscopic image as a three-dimensional image by observing the stereoscopic image generated as described above using a stereoscopic display.

As an example of the configuration of such a stereoscopic display, a configuration may be mentioned in which two images are displayed using two corresponding screens and a half mirror, polarizing glasses, and the like are used to make one image visible to the right eye of an observer and the other image visible to the left eye of the observer. In addition, a configuration may be adopted in which two images are displayed so as to overlap each other by shifting them from each other by the predetermined amount of parallax and the overlapped image is observed through the polarizing glasses by the observer. In addition, like a parallax barrier method and a lenticular method, a configuration may be adopted in which two images are displayed by dividing the space in a special 3D display so that the observer can observe the images. In addition, like a head mounted display, a configuration may be adopted in which dedicated small displays for the left and right eyes are prepared and left and right images are respectively displayed on these small displays so that the observer can observe the images.

### SUMMARY OF THE INVENTION

However, when displaying two images using two screens for stereoscopic viewing, the luminances of the two images actually observed by the observer are different. Accordingly, a problem may occur in that satisfactory stereoscopic viewing cannot be realized. Specifically, in the above case, a problem may occur in that it takes time until the observer can recognize a subject in a three-dimensional manner, the observer feels fatigued while performing stereoscopic viewing, or the observer cannot recognize a subject in a natural state. This is because the amounts of light output from the two screens are different or the light propagation paths during stereoscopic display are different and accordingly, the amounts of energy loss of the image signals are different. As a result, since the brightnesses of images actually observed by the left and right eyes are different, the harmony of the two images mixed in the brain of the observer is disrupted.

In addition, the above problems are not limited to apparatuses including a screen which displays an image. That is, these are common problems when performing stereoscopic display using two light output units that outputs light signals of images in apparatuses involving a projector for projecting an image onto a screen.

The present invention has been made in view of the above-mentioned problems and an object of the present invention is to provide an adjustment method of a stereoscopic display and an adjustment device used therefore capable of further reducing the burden on an observer, which is caused by the difference between light outputs of two light output units or by the difference between light propagation paths of two light signals.

In addition, it is another object of the present invention to provide a stereoscopic image display method and a display device used therefore capable of further reducing the burden on an observer, which is caused by the difference between light outputs of two light output units or by the difference between light propagation paths of two light signals.

In order to solve the above-described problem, according to an aspect of the present invention, an adjustment method of a stereoscopic display which stereoscopically display images for right eye and left eye having parallax with respect to each other, the display having a light output unit for the right eye which outputs a light signal for the right eye to display the image for the right eye, and a light output unit for the left eye which outputs a light signal for the left eye to display the image for the left eye, wherein the method comprising steps of; performing first measurement for measuring the luminance of the light signal for the right eye; performing second measurement for measuring the luminance of the light signal for the left eye; acquiring first and second representative luminance values corresponding to each other by the first and second measurements, respectively; and adjusting an output of the light output unit for the right eye and/or the light output unit for the left eye such that a difference between the first representative luminance value acquired by the first measurement and the second representative luminance value acquired by the second measurement falls within a predetermined range.

In this specification, the “stereoscopic display” means a display system including polarizing glasses or a display device which outputs two image signals with parallax so that an observer can recognize a three-dimensional image through stereoscopic viewing.

The “light output unit for the right eye (or the light output unit for the left eye) which outputs the light signal for the right eye (or the light signal for the left eye) for displaying the image for the right eye (or the image for the left eye)” means a device which outputs a light signal of an image for the right eye (or an image for the left eye) in order to make the observer observe the image for the right eye (or the image for the left eye). Examples of the “light output unit for the right eye (or the light output unit for the left eye) which outputs the light signal for the right eye (or the light signal for the left eye) for displaying the image for the right eye (or the image for the left eye)” include a device with a screen on which an image is displayed and a projector for projecting an image onto the screen.

The “display for stereoscopic viewing” means displaying constituent images of a stereoscopic image in a state where all conditions required for stereoscopic viewing are satisfied at the display side of a stereoscopic image. Examples of the “display for stereoscopic viewing” include displaying constituent images of a stereoscopic image are displayed side-by-side in right-left direction, making constituent images of a stereoscopic image overlap each other on a half mirror in different polarization states and displaying the overlapped image through polarizing glasses or the like, and displaying constituent images of a stereoscopic image using a lenticular display.

The “luminance of a light signal for the right eye (or a light signal for the left eye)” means the overall brightness of an output light signal for the right eye (or an output light signal for the left eye).

“Corresponding to each other” means that the first and second representative luminance values are acquired in the same acquisition conditions so as to be contrasted with each other.

The “representative luminance value” means a luminance value indicating the trend of the representative luminance when the luminance of a light signal for the right eye (or a light signal for the left eye) is expressed as numbers.

Moreover, in the adjustment method of a stereoscopic display according to the aspect of the present invention, it is preferable that the first measurement be performed while outputting one or more light signals for the right eye which displays one or more reference images respectively for luminance measurement and the second measurement be performed while outputting one or more light signals for the left eye which displays the one or more reference images respectively.

In this specification, the “reference image” means a predetermined image which is displayed in order to make the measurement conditions equal when measuring the luminance of each of the light signal for the right eye and the light signal for the left eye.

Moreover, in the above case, it is preferable that a first luminance value be measured while outputting the light signal for the right eye for displaying a black image as the reference image and a second luminance value be measured while outputting the light signal for the right eye for displaying a white image as the reference image in the first measurement, the first representative luminance value be set in a range of the first luminance value to the second luminance value, a third luminance value be measured while outputting the light signal for the left eye for displaying a black image as the reference image and a fourth luminance value be measured while outputting the light signal for the left eye for displaying a white image as the reference image in the second measurement, and the second representative luminance value be set in a range of the third luminance value to the fourth luminance value. In this case, it is preferable to extract the first luminance value, the second luminance value, or an average value of the first and second luminance values as the first representative luminance value and to extract the third luminance value, the fourth luminance value, or an average value of the third and fourth luminance values as the second representative luminance value.

Moreover, in the adjustment method of a stereoscopic display according to the aspect of the present invention, it is preferable that an average value of the luminance of the light signal for the right eye in a predetermined period for which one or more reference images are displayed be extracted as the first representative luminance value and an average value of the luminance of the light signal for the left eye in a predetermined period for which one or more reference images are displayed be extracted as the second representative luminance value.

Moreover, in the adjustment method of a stereoscopic display according to the aspect of the present invention, it is preferable to perform the first measurement in a state where the light signal for the left eye is not output and to perform the second measurement in a state where the light signal for the right eye is not output.

In addition, the stereoscopic display may be a display using a polarizing filter method, a lenticular display, or a head mounted display.

In addition, according to another aspect of the present invention, an adjustment device of a stereoscopic display which stereoscopically display images for right eye and left eye having parallax with respect to each other, the display having a light output unit for the right eye which outputs a light signal for the right eye to display the image for the right eye, and a light output unit for the left eye which outputs a light signal for the left eye to display the image for the left eye, wherein the adjustment device comprising: measurement means for performing first measurement for measuring the luminance of the light signal for the right eye, performing second measurement for measuring the luminance of the light signal for the left eye, and acquiring first and second representative luminance values corresponding to each other by the first and second measurements, respectively; and adjustment means for adjusting an output of the light output unit for the right eye and/or the light output unit for the left eye such that a difference between the first representative luminance value acquired by the first measurement and the second representative luminance value acquired by the second measurement falls within a predetermined range.

Moreover, in the adjustment device of a stereoscopic display according to the aspect of the present invention, it is preferable that the measurement means perform the first measurement while outputting one or more light signals for the right eye which displays one or more reference images respectively for luminance measurement and perform the second measurement while outputting one or more light signals for the left eye which displays the one or more reference images respectively.

Moreover, in the adjustment device of a stereoscopic display according to the aspect of the present invention, it is preferable that the measurement means measure a first luminance value while outputting the light signal for the right eye for displaying a black image as the reference image and measure a second luminance value while outputting the light signal for the right eye for displaying a white image as the reference image in the first measurement, the measurement means extract the first representative luminance value in a range of the first luminance value to the second luminance value, the measurement means measure a third luminance value while outputting the light signal for the left eye for displaying a black image as the reference image and measure a fourth luminance value while outputting the light signal for the left eye for displaying a white image as the reference image in the second measurement, and the measurement means extract the second representative luminance value in a range of the third luminance value to the fourth luminance value.

Moreover, in the adjustment device of a stereoscopic display according to the aspect of the present invention, it is preferable that the measurement means extract, as the first representative luminance value, an average value of the luminance of the light signal for the right eye in a predetermined period for which one or more reference images are displayed and extract, as the second representative luminance value, an average value of the luminance of the light signal for the left eye in a predetermined period for which the one or more reference images are displayed.

In addition, according to still another aspect of the present invention, a stereoscopic image display method of displaying a stereoscopic image including an image for a right eye and an image for a left eye with parallax for stereoscopic viewing using a stereoscopic display includes: adjusting the stereoscopic display using the adjustment method of a stereoscopic display described above; and displaying the stereoscopic image on the stereoscopic display for stereoscopic viewing.

In addition, according to still another aspect of the present invention, a stereoscopic image display device includes: a stereoscopic display; a display controller which displays a stereoscopic image, which includes an image for a right eye and an image for a left eye with parallax, on the stereoscopic display for stereoscopic viewing; and the adjustment device of a stereoscopic display described above which adjusts the stereoscopic display.

According to the adjustment method of a stereoscopic display and the adjustment device used therefore according to the aspects of the present invention, ┌the adjustment method of a stereoscopic display having a light output unit for the right eye which outputs a light signal for the right eye for displaying the image for the right eye and a light output unit for the left eye which outputs a light signal for the left eye for displaying the image for the left eye includes: performing the first measurement for measuring the luminance of the light signal for the right eye; performing the second measurement for measuring the luminance of the light signal for the left eye; acquiring the first and second representative luminance values corresponding to each other by the first and second measurements, respectively; and adjusting the output of the light output unit for the right eye and/or the light output unit for the left eye such that the difference between the first representative luminance value acquired by the first measurement and the second representative luminance value acquired by the second measurement falls within a predetermined range. Therefore, an adjustment to make the luminance of two light signals actually observed by the observer equal can be realized. As a result, in the adjustment method of a stereoscopic display used for stereoscopic display and the adjustment device used therefore, the burden on the observer caused by the difference between light outputs of two light output units or by the difference between light propagation paths of two light signals can be reduced.

In addition, since the stereoscopic image display method and the display device used therefore according to the aspects of the present invention use the adjustment method of a stereoscopic display and the adjustment device used therefore described above, a stereoscopic image can be displayed for stereoscopic viewing by adjusting the luminance of two light signals, which are actually observed by the observer, to be equal. As a result, in the stereoscopic image display method and the display device used therefore, the burden on the observer caused by the difference between light outputs of two light output units or by the difference between light propagation paths of two light signals can be reduced.

### BRIEF DESCRIPTION OF THE DRAWINGS

FIG. 1 is a view showing the schematic configuration of a breast image radiographing display system using a stereoscopic image display method and a stereoscopic image display device according to an embodiment of the present invention.

FIG. 2 is a schematic sectional view showing an arm unit of the breast image radiographing display system shown in FIG. 1.

FIG. 3 is a block diagram showing the schematic configuration in a computer of the breast image radiographing display system shown in FIG. 1.

FIG. 4A is a schematic view showing the configuration of a polarizing film type display system to which the present invention is applied.

FIG. 4B is a view for explaining one process of performing luminance adjustment of the polarizing film type display system by applying an adjustment method of the present invention.

FIG. 4C is a view for explaining one process of performing luminance adjustment of the polarizing film type display system by applying the adjustment method of the present invention.

FIG. 5A is a schematic view showing the configuration of a lenticular display system to which the present invention is applied.

FIG. 5B is a view for explaining one process of performing luminance adjustment of the lenticular display system by applying the adjustment method of the present invention.

FIG. 5C is a view for explaining one process of performing luminance adjustment of the lenticular display system by applying the adjustment method of the present invention.

FIG. 6A is a schematic view showing the configuration of a projection type display system to which the present invention is applied.

FIG. 6B is a view for explaining one process of performing luminance adjustment of the projection type display system by applying the adjustment method of the present invention.

FIG. 6C is a view for explaining one process of performing luminance adjustment of the projection type display system by applying the adjustment method of the present invention.

### DESCRIPTION OF THE PREFERRED EMBODIMENTS

Hereinafter, embodiments of the present invention will be described with reference to the accompanying drawings. However, the present invention is not limited to these. In addition, the scale of each component is appropriately adjusted in order to have a recognizable size in the drawings described below.

[Adjustment method of a stereoscopic display, an adjustment device used therefore, a stereoscopic image display method, and a display device used therefore in a first embodiment]

An adjustment method of a stereoscopic display, an adjustment device used therefore, a stereoscopic image display method, and a display device used therefore according to a first embodiment of the present invention will be described. Moreover, in the present embodiment of the present invention, the case where the adjustment method of a stereoscopic display, the adjustment device used therefore, the stereoscopic image display method, and the display device used therefore are applied to a breast image radiographing display system will be described as an example.

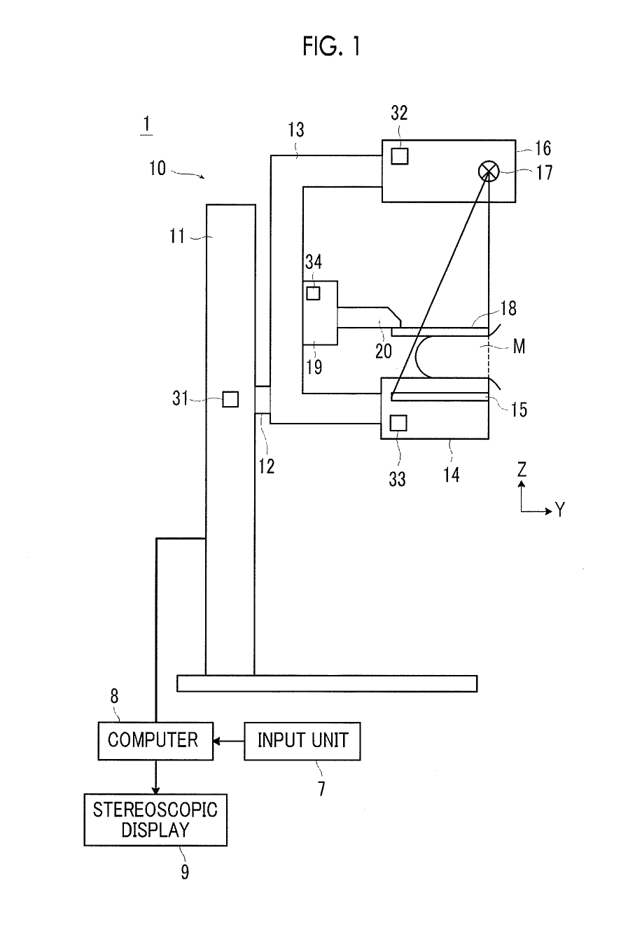

As shown in FIG. 1, a breast image radiographing display system 1 according to the present embodiment includes a breast image radiographing apparatus 10, a computer 8 connected to the breast image radiographing apparatus 10, and a stereoscopic display 9 and an input unit 7 connected to the computer 8.

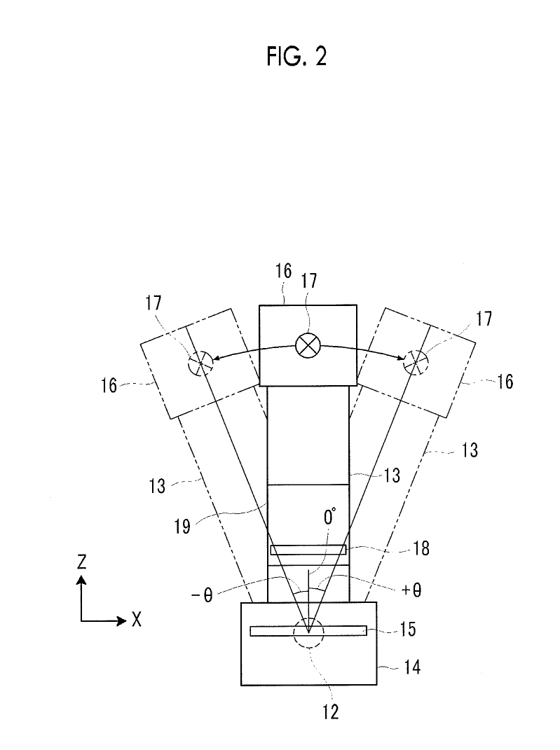

As shown in FIG. 1, the breast image radiographing apparatus 10 includes a pedestal 11, a rotary shaft 12 which can rotate and move up and down (in a Z direction) with respect to the pedestal 11, and an arm unit 13 connected to the pedestal 11 by the rotary shaft 12. In addition, FIG. 2 shows the front shape of the arm unit 13 when viewed from the right direction (positive direction on the y axis) in FIG. 1.

The arm unit 13 has a shape of alphabet C. A radiography platform 14 is fixed to one end of the arm unit 13, and an irradiating unit 16 is fixed to the other end so as to face the radiography platform 14. Rotation and up-and-down movement of the arm unit 13 are controlled by an arm controller 31 provided in the pedestal 11.

A radiological image detector 15, such as a flat panel detector, and a detector controller 33 which controls reading of a charge signal from the radiological image detector 15 are provided inside the radiography platform 14. In addition, although a circuit board on which a charge amplifier that converts a charge signal read from the radiological image detector 15 into a voltage signal, a correlated double sampling circuit that samples a voltage signal output from the charge amplifier, an AD converter that converts a voltage signal into a digital signal, and the like are provided is placed inside the radiography platform 14, detailed explanation thereof will be omitted.

The radiography platform 14 is configured to be able to rotate with respect to the arm unit 13. Accordingly, even when the arm unit 13 rotates around the rotary shaft 12 with respect to the pedestal 11, the radiography platform 14 is maintained in a fixed direction with respect to the pedestal 11.

The radiological image detector 15 can perform recording and reading of a radiological image repeatedly. A so-called direct-conversion type radiological image detector which generates an electric charge by direct reception of radiation may be used, or a so-called indirect-conversion type radiological image detector which converts radiation into visible light and then converts the visible light into a charge signal may be used. Moreover, as a method of reading a radiological image signal, a so-called TFT (thin film transistor) reading method in which a radiological image signal is read by ON/OFF of a TFT switch or a so-called optical reading method in which a radiological image signal is read by irradiation of reading light is preferably used. However, other methods may be used without being limited to the above methods.

A radiation source 17 and a radiation source controller 32 are provided in the irradiating unit 16. The radiation source controller 32 controls an irradiation timing of radiation from the radiation source 17 and the radiation generating conditions (tube current time product) in the radiation source 17.

A compression plate 18 provided above the radiography platform 14 to compress a breast M, a supporting unit 20 which supports the compression plate 18, and a moving mechanism 19 which moves the supporting unit 20 up and down (in the Z-axis direction) are provided in the middle of the arm unit 13. The position and the pressure of the compression plate 18 are controlled by the compression plate controller 34.

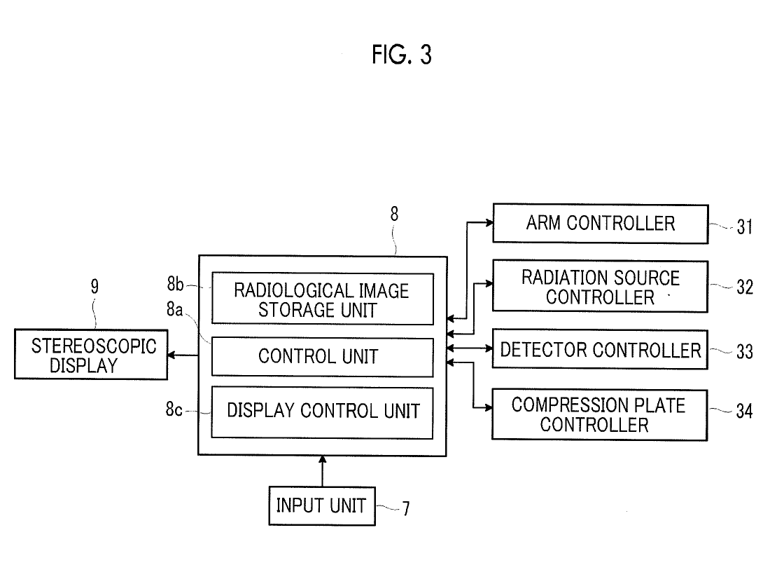

The computer 8 which controls the operation of the breast image radiographing apparatus 10 includes a central processing unit (CPU) and a storage device, such as a semiconductor memory, a hard disk, or an SSD. By such hardware, a controller 8a, a radiological image storage unit 8b, and a display controller 8c shown in FIG. 3 are formed.

The controller 8a outputs predetermined control signals to various kinds of controllers 31 to 34 to control the entire system. A specific control method will be described in detail later.

The radiological image storage unit 8b stores a radiological image signal acquired by the radiological image detector 15.

The display controller 8c reads the radiological image signal stored in the radiological image storage unit 8b and generates a stereoscopic image, which includes a radiological image for the right eye and a radiological image for the left eye, based on the radiological image signal. Then, the display controller 8c displays the generated stereoscopic image of the breast M on the stereoscopic display 9 for stereoscopic viewing (stereoscopic display).

For example, the input unit 7 includes a keyboard or a pointing device, such as a mouse, and receives from a radiographer an input of radiographing conditions, an input of a radiographing start instruction, and the like.

The stereoscopic display 9 is configured to perform stereoscopic display of a stereoscopic image using two radiological image signals stored in the computer 8. As an example of the configuration for stereoscopic display of a stereoscopic image, a configuration may be mentioned in which radiological images based on two radiological image signals are displayed using two corresponding screens and a half mirror, polarizing glasses, and the like are used to make one of the radiological images visible to the right eye of an observer and the other radiological image visible to the left eye of the observer. In addition, a configuration may be adopted in which two images are displayed so as to overlap each other by shifting them from each other by the predetermined amount of parallax and the overlapped image is observed through the polarizing glasses by the observer. Moreover, like a parallax barrier method and a lenticular method, a configuration may be adopted in which two images are displayed by dividing the space in a special 3D display so that the images are observed by the observer. In addition, like a head mounted display, a configuration may be adopted in which dedicated small displays for the left and right eyes are prepared and left and right images are respectively displayed on these small displays so that the observer can observe the images.

In the present embodiment, the case where a polarizing film type display system 9A using a half mirror or polarizing glasses is adopted as the stereoscopic display 9 will be specifically described as an example.

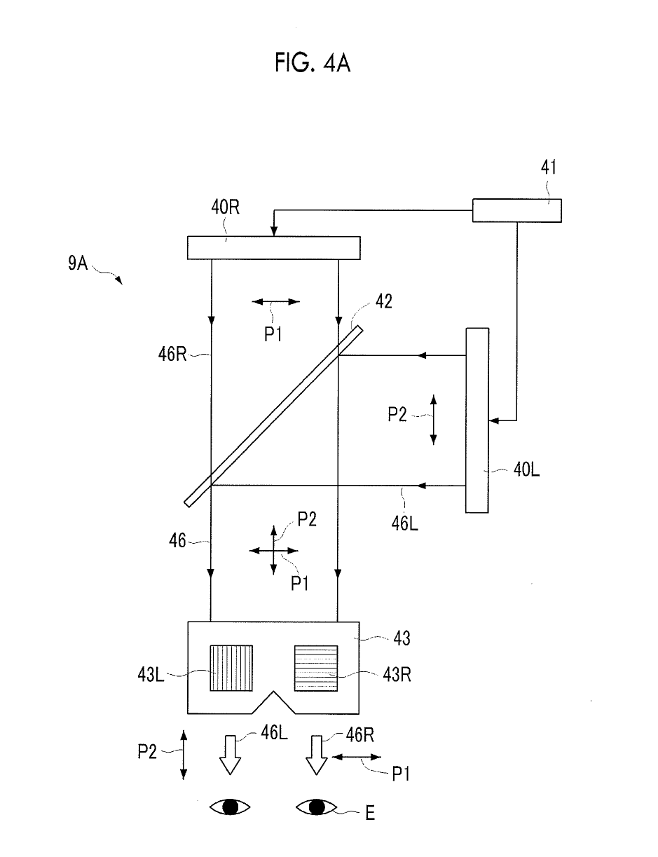

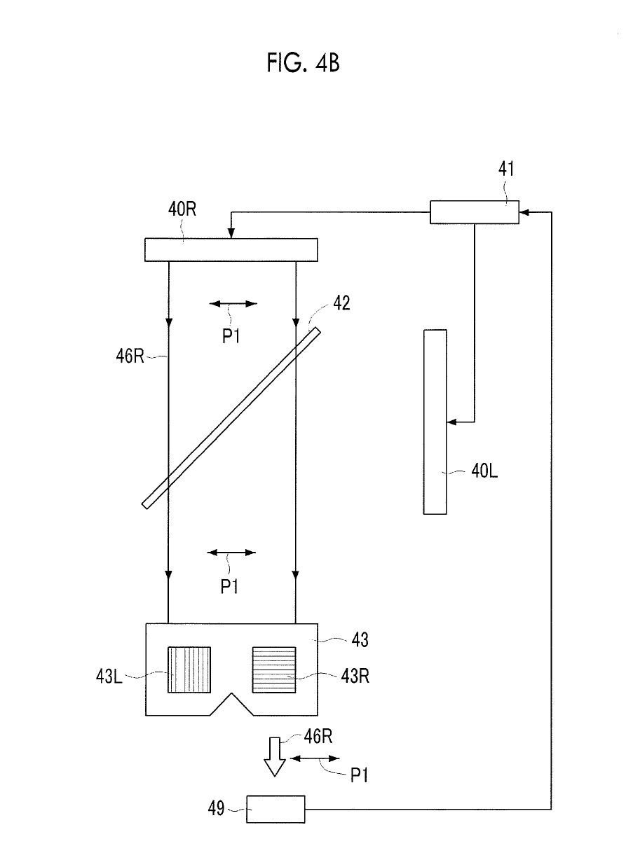

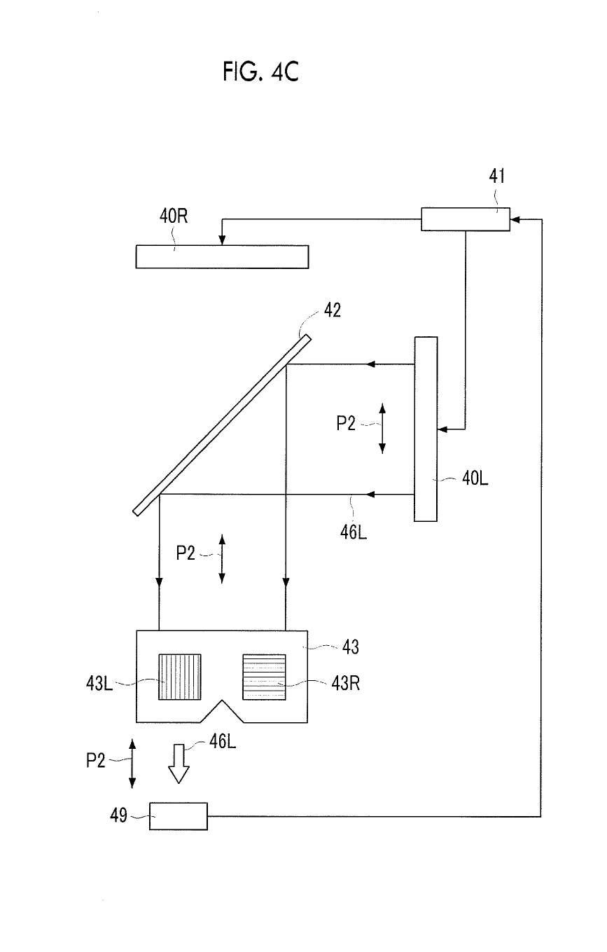

FIG. 4A is a schematic view showing the configuration of the polarizing film type display system 9A of the present embodiment. The polarizing film type display system 9A includes a light output unit for the right eye 40R which outputs a light signal for the right eye 46R for displaying an image for the right eye, a light output unit for the left eye 40L which outputs a light signal for the left eye 46L for displaying an image for the left eye, an adjustment unit 41 that adjusts outputs of the light output units, a half mirror 42, polarizing glasses 43, and a luminance meter 49 (not shown). The adjustment unit 41 and the luminance meter 49 form an adjustment device of the stereoscopic display in the present embodiment.

The light output unit for the right eye 40R and the light output unit for the left eye 40L are light output units whose outputs can be separately controlled, and the light output unit for the right eye 40R and the light output unit for the left eye 40L are disposed such that the output directions of their light signals are perpendicular to each other. Moreover, for example, the light output unit for the right eye 40R and the light output unit for the left eye 40L are liquid crystal panels. Polarizing filters (not shown) with polarization directions perpendicular to each other are provided on surfaces of the light output unit for the right eye 40R and the light output unit for the left eye 40L. Accordingly, a light signal polarized in a horizontal direction P1 (left and right directions on the plane in the drawing; the same hereinbelow) is output from the light output unit for the right eye 40R. On the other hand, a light signal polarized in a vertical direction P2 (direction perpendicular to the plane in the drawing (for the sake of convenience, the arrow is shown in the up and down directions on the plane); the same hereinbelow) is output from the light output unit for the left eye 40L.

The adjustment unit 41 functions as adjustment means in the present invention, and controls backlights of the light output unit for the right eye 40R and the light output unit for the left eye 40L to adjust the outputs, for example. For example, the adjustment unit 41 includes a memory for storing a measurement result of the luminance meter 49 which will be described later.

The half mirror 42 is provided at the position where the light signal for the right eye 46R output from the light output unit for the right eye 40R and the light signal for the left eye 46L output from the light output unit for the left eye 40L cross each other. In addition, the half mirror 42 allows the light signal for the right eye 46R to be transmitted therethrough and reflects the light signal for the left eye 46L in a direction of the polarizing glasses 43. As a result, a mixed signal 46 of the light signal for the right eye 46R and the light signal for the left eye 46L is formed on the half mirror 42.

The polarizing glasses 43 include a polarizing filter 43R, which allows the light signal for the right eye 46R polarized in the horizontal direction P1 to be transmitted therethrough, and a polarizing filter 43L, which allows the light signal for the left eye 46L polarized in the vertical direction P2 to be transmitted therethrough. The polarizing glasses 43 are configured such that the polarizing filter 43R faces the right eye and the polarizing filter 43L faces the left eye when an observer E wears glasses. The observer E observes the mixed signal 46 through the polarizing glasses 43. In this case, since the polarizing filter 43R allows only the light signal for the right eye 46R polarized in the horizontal direction P1 to be transmitted therethrough and the polarizing filter 43L allows only the light signal for the left eye 46L polarized in the vertical direction P2 to be transmitted therethrough, only the light signal for the right eye 46R is received by the right eye of the observer and only the light signal for the left eye 46L is received by the left eye. As a result, since the observer E can recognize two images with parallax by the respective left and right eyes, stereoscopic viewing can be realized.

The luminance meter 49 functions as measurement means in the present invention, and measures the luminance of a light signal output from the light output unit. When measuring the luminance, the luminance meter 49 is usually disposed so as to detect a light signal transmitted through the polarizing glasses 43, that is, so as to detect a light signal output from the polarizing film type display system 9A. However, the arrangement of the luminance meter 49 is not limited to this. For example, when the influence of the polarizing glasses 43 on the difference of the luminance between two light signals transmitted therethrough is small, the luminance meter 49 may be disposed so as to detect a light signal propagating between the half mirror 42 and the polarizing glasses 43. In addition, when the influence of the polarizing glasses 42 on the difference of the luminance between two light signals transmitted therethrough or reflected therefrom is also small, the luminance meter 49 may also be disposed so as to detect a light signal propagating between the light output unit for the right eye 40R or the light output unit for the left eye 40L and the half mirror 40. That is, although the luminance meter 49 is usually disposed so as to detect a light signal output from the display system 9A, the luminance meter 49 is disposed so as to detect a light signal propagating through the polarizing film type display system 9A when necessary.

<Radiographing Processing>

Next, radiographing processing in the breast image radiographing apparatus 10 will be described. First, as shown in FIG. 1, the breast M is placed on the radiography platform 14 and is compressed with predetermined pressure by the compression plate 18. At this point of time, the arm unit 13 is set at the initial position in a direction perpendicular to the radiography platform 14, that is, at the position indicated by the solid line in FIG. 2.

Then, through the input unit 7, various kinds of radiographing conditions changing with each subject are input and also an instruction indicating whether to radiograph a radiological image as a stereoscopic image or as a normal two-dimensional image is input. When an instruction to radiograph a radiological image as a stereoscopic image is input, the controller 8a reads a radiographing angle θ (angle between the normal line of the radiation detection surface and the irradiation axis: refer to FIG. 2) set in advance from an internal memory and outputs the information regarding the radiographing angle θ to the arm controller 31.

In addition, in the present embodiment, θ=2° is assumed to be stored in advance as the information regarding the radiographing angle θ. However, other angles of about 2° to 5° may also be applied as the radiographing angle θ without being limited to θ=2°. Moreover, in the present embodiment, the arm unit 13 is configured to be able to rotate around the rotary shaft 12, and the rotary shaft 12 is located at approximately the same height as the radiological image detector 15. For this reason, as shown in FIG. 2, the irradiation axes of the radiation source 17 located at different rotary positions cross each other near the radiological image detector 15. However, the arm unit 13 may be made to rotate such that these irradiation axes cross each other in the center of the breast M, which is a subject, without being limited to the above.

Then, the arm controller 31 receives the information regarding the radiographing angle θ output from the controller 8a and outputs a control signal, which is for rotating the arm unit 13 by +0 from the initial position, based on the information regarding the radiographing angle θ. Then, in response to this control signal, the arm unit 13 rotates by +2°.

Then, the controller 8a outputs a control signal to the radiation source controller 32 and the detector controller 33 so as to perform irradiation and reading of a radiological image signal. Then, radiation is emitted from the radiation source 17 in response to this control signal, and a radiological image signal obtained by radiographing a breast from the direction of +2° is detected by the radiological image detector 15. Then, a radiological image signal is read from the radiological image detector 15 by the detector controller 33. Predetermined signal processing is performed on the radiological image signal, and then the radiological image signal is stored in the radiological image storage unit 8b of the computer 8.

Then, the arm controller 31 returns the arm unit 13 to the initial position and then outputs a control signal for rotating the arm unit 13 by −θ from the initial position. As a result, the arm unit 13 rotates by −2° from the initial position.

Then, the controller 8a outputs a control signal to the radiation source controller 32 and the detector controller 33 so as to perform irradiation and reading of a radiological image signal. Then, radiation is emitted from the radiation source 17 in response to this control signal, and a radiological image signal obtained by radiographing a breast from the direction of −2° is detected by the radiological image detector 15. Then, a radiological image signal is read from the radiological image detector 15 by the detector controller 33. Predetermined signal processing is performed on the radiological image signal, and then the radiological image signal is stored in the radiological image storage unit 8b of the computer 8.

In this way, two radiological images with parallax are obtained.

In addition, although two radiological images which form a stereoscopic image are radiographed by changing the irradiation direction on the X-Z plane shown in FIG. 2 in the present embodiment, a plurality of radiological images may be radiographed by changing the irradiation direction to another direction. That is, a plurality of radiological images may also be radiographed by changing the irradiation direction on the Y-Z plane shown in FIG. 2 (plane perpendicular to the plane of FIG. 2), for example.

<Display Processing>

Next, display processing in this breast image radiographing display system 1 will be described.

In the present embodiment, the case will be described in which a stereoscopic image of the breast M of a subject is displayed on the polarizing film type display system 9A based on two radiological image signals stored in the radiological image storage unit 8b by radiographing described above. That is, this stereoscopic image is formed by two radiological images obtained by performing the radiographing described above twice. More specifically, for example, a radiological image obtained by first radiographing is used as an image for the right eye of the stereoscopic image and a radiological image obtained by second radiographing is used as an image for the left eye of the stereoscopic image.

First, an observer performs luminance adjustment of light signals output from two light output units of the polarizing film type display system 9A before performing stereoscopic viewing with the polarizing film type display system 9A. This is to further reduce the burden on the observer caused by the difference between light outputs of two light output units or by the difference between light propagation paths of two light signals.

Specifically, such luminance adjustment is performed through the following procedure using the adjustment device of the stereoscopic display according to the present embodiment.

(1. Acquisition of a Representative Luminance Value of a Light Signal for the Right Eye)

First, first measurement for measuring the luminance of a light signal for the right eye is performed. As shown in FIG. 4B, for example, the first measurement is performed by measuring the luminance of the light signal for the right eye 46R using the luminance meter 49 in a state where a reference image is displayed on the light output unit for the right eye 40R and the light output unit for the left eye 40L is not driven (light output is off). Thus, if the first measurement is performed in a state where the light output of the light output unit for the left eye 40L is off, only the luminance characteristic of the light signal for the right eye 46R can be accurately measured. More specifically, in the first measurement, a first luminance value is measured while outputting the light signal for the right eye 46R for displaying a black image as a reference image, a second luminance value is measured while outputting the light signal for the right eye 46R for displaying a white image as a reference image, and a first representative luminance value is extracted from the luminance range of the first luminance value to the second luminance value. The result measured by the luminance meter 49 is output to the adjustment unit 41 and is stored in a memory of the adjustment unit 41, for example. Then, the average value of the first and second luminance values is calculated by the adjustment unit 41, and this average value is set as a (first) representative luminance value of the light signal for the right eye 46R. Alternatively, either the first luminance value or the second luminance value may be set as the (first) representative luminance value of the light signal for the right eye 46R. Then, the representative luminance value is stored in the adjustment unit 41.

In the present embodiment, in order to detect a light signal of an image for the right eye displayed on the polarizing film type display system 9A, that is, the light signal for the right eye 46R actually observed by the observer E, the luminance meter 49 is disposed so as to detect the light signal for the right eye 46R transmitted through the polarizing filter 43R of the polarizing glasses 43. Accordingly, it becomes possible to measure the luminance taking into consideration comprehensively the size of an output as performance of the light output unit for the right eye 40R, the amount of energy loss of the light signal for the right eye 46R caused during stereoscopic display propagation, and the like.

(2. Acquisition of a Representative Luminance Value of a Light Signal for the Left Eye)

Next, second measurement for measuring the luminance of a light signal for the left eye is performed. As shown in FIG. 4C, for example, the second measurement is performed by measuring the luminance of the light signal for the left eye 46L using the luminance meter 49 in a state where a reference image is displayed on the light output unit for the left eye 40L and the light output unit for the right eye 40R is not driven (light output is off). Thus, if the second measurement is performed in a state where the light output of the light output unit for the right eye 40R is off, only the luminance characteristic of the light signal for the left eye 46L can be accurately measured. More specifically, in the second measurement, a third luminance value is measured while outputting the light signal for the left eye 46L for displaying a black image as a reference image, a fourth luminance value is measured while outputting the light signal for the left eye 46L for displaying a white image as a reference image, and a second representative luminance value is extracted from the luminance range of the third luminance value to the fourth luminance value. The result measured by the luminance meter 49 is output to the adjustment unit 41 and is stored in a memory of the adjustment unit 41, for example. Then, the average value of the third and fourth luminance values is calculated by the adjustment unit 41, and this average value is set as a (second) representative luminance value of the light signal for the left eye 46L. Alternatively, either the third luminance value or the fourth luminance value may be set as the (second) representative luminance value of the light signal for the left eye 46L. Then, the representative luminance value is stored in the adjustment unit 41.

Also in the second measurement, the luminance meter 49 is disposed at the same position as in the first measurement since the second representative luminance value corresponding to the first representative luminance value needs to be acquired under the conditions of luminance measurement. However, in the second measurement, the luminance meter 49 is disposed so as to detect the light signal for the left eye 46L transmitted through the polarizing filter 43L of the polarizing glasses 43.

As described above, the first and second representative luminance values corresponding to each other are acquired by the first and second measurements, respectively. Moreover, in the first and second processes described above, a black image and a white image of light signals are displayed to measure the representative luminance value. However, the black image and the white image are not necessarily displayed in order to calculate the representative luminance value. That is, the luminance of a light signal may be measured by displaying images of arbitrary colors as reference images on both the light output units, and the obtained luminance may be set as each representative luminance value. In such a case, the average value of the luminance of a light signal in a predetermined period for which one or more reference images are displayed may also be extracted as a representative luminance value. In addition, the reference image is not limited to a monochromatic still image, and a plurality of color may be included or a figure, a symbol, and the like may be included. In addition, the reference image may be a moving image.

(3. Luminance Adjustment Based on the Representative Luminance Value)

Then, the adjustment unit 41 adjusts outputs of the light output unit for the right eye 40R and the light output unit for the left eye 40L in the polarizing film type display system 9A such that a difference between the representative luminance value of the light signal for the right eye 46R and the representative luminance value of the light signal for the left eye 46L acquired as described above falls within a predetermined range. Specifically, the adjustment unit 41 compares the representative luminance value of the light signal for the right eye 46R with the representative luminance value of the light signal for the left eye 46L, and adjusts the output of the light output unit for the right eye 40R and/or the light output unit for the left eye 40L such that the difference falls within a predetermined range while aligning the larger one with the smaller one. For example, the luminance can be adjusted by performing integral multiples of the output of the light output unit with a larger representative luminance value. Moreover, in the present embodiment, the predetermined range is preferably set to be 30% or less of the smaller representative luminance value. If the difference is 40% or more of the smaller representative luminance value, distortion occurs according to the Pulfrich effect. As a result, a sense of depth becomes unstable.

If the luminance adjustment ends through the above procedure, the observer inputs to the input unit 7 an instruction to display a stereoscopic image of the breast M. In response to the display instruction, two radiological image signals of the subject are read from the radiological image storage unit 8b by the display controller 8c. Then, the display controller 8c performs stereoscopic display of a stereoscopic image, which includes a radiological image for the right eye and a radiological image for the left eye generated based on the two radiological image signals, on the stereoscopic display 9. Since the observer can perform stereoscopic viewing based on the luminance-adjusted light signal, satisfactory stereoscopic viewing can be performed.

### Second Embodiment

An adjustment method of a stereoscopic display, an adjustment device used therefore, a stereoscopic image display method, and a display device used therefore according to a second embodiment of the present invention will be described. In addition, the present embodiment is different from the first embodiment in that the stereoscopic display 9 shown in FIG. 1 is a lenticular display system. Accordingly, details of the same components as in the first embodiment will be omitted if not necessary.

In the present embodiment, the case where a lenticular display system 9B is adopted as the stereoscopic display 9 will be specifically described.

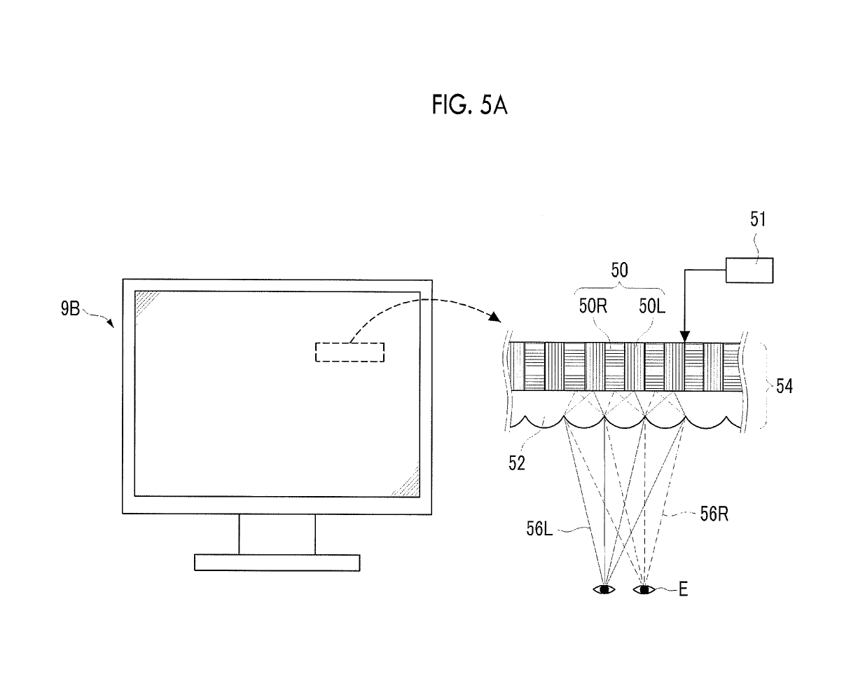

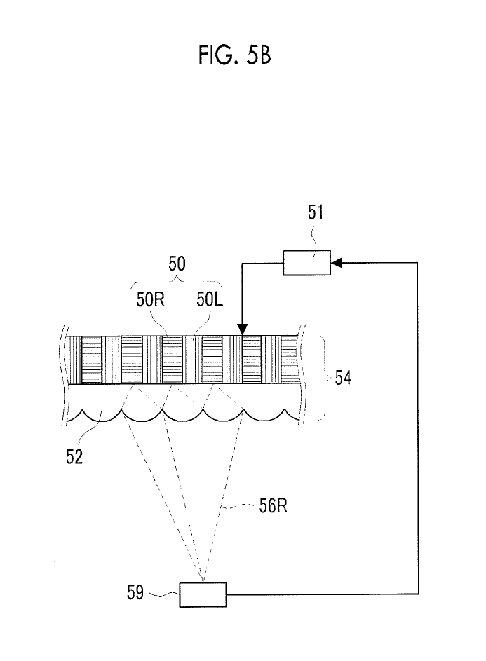

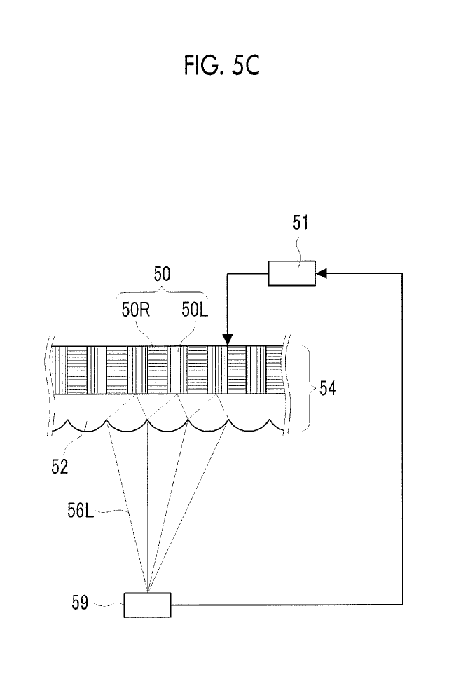

FIG. 5A is a schematic view showing the configuration of the lenticular display system 9B of the present embodiment. The lenticular display system 9B includes a lenticular panel 54, an adjustment unit 51, and a luminance meter 59. The adjustment unit 51 and the luminance meter 59 form an adjustment device of the stereoscopic display in the present embodiment.

The lenticular panel 54 includes a liquid crystal panel 50 and a lenticular lens 52 bonded to the front surface of the liquid crystal panel 50.

The liquid crystal panel 50 includes a light output unit for the right eye 50R, which outputs a light signal for the right eye 56R for displaying an image for the right eye, and a light output unit for the left eye 50L, which outputs a light signal for the left eye 56L for displaying an image for the left eye. The liquid crystal panel 50 has a structure in which a plurality of pixel lines, which form the light output unit for the right eye 50R, and a plurality of pixel lines, which form the light output unit for the left eye 50L, are alternately arrayed in the shape of stripes. That is, the light output unit for the right eye 50R is formed by all of the plurality of odd-numbered pixel lines, and the light output unit for the left eye 50L is formed by all of the plurality of even-numbered pixel lines, for example.

The light output unit for the right eye 50R and the light output unit for the left eye 50L are light output units whose outputs can be separately controlled.

The lenticular lens 52 is formed by a plurality of long and narrow cylindrical lenses. One cylindrical lens is bonded corresponding to one pixel line of the light output unit for the right eye 50R and one pixel line of the light output unit for the left eye 50L adjacent thereto. Through this lenticular lens 52, the light signal for the right eye 56R output from the light output unit for the right eye 50R is received by the right eye of the observer and the light signal for the left eye 56L output from the light output unit for the left eye 50L is received by the left eye of the observer.

The adjustment unit 51 functions as adjustment means in the present invention, and controls backlights of the light output unit for the right eye 50R and the light output unit for the left eye 50L to adjust the outputs, for example. For example, the adjustment unit 51 includes a memory for storing a measurement result of the luminance meter 59 which will be described later.

The luminance meter 59 functions as measurement means in the present invention, and measures the luminance of a light signal output from the light output unit. When measuring the luminance, the luminance meter 59 is disposed on the front surface of the lenticular panel 54.

Specifically, such luminance adjustment in the present embodiment is performed through the following procedure using the adjustment device of the stereoscopic display according to the present embodiment.

(1. Acquisition of a Representative Luminance Value of a Light Signal for the Right Eye)

First, first measurement for measuring the luminance of a light signal for the right eye is performed. As shown in FIG. 5B, for example, the first measurement is performed by measuring the luminance of the light signal for the right eye 56R using the luminance meter 59 in a state where a reference image is displayed on the light output unit for the right eye 50R and the light output unit for the left eye 50L is not driven (light output is off). Thus, if the first measurement is performed in a state where the light output of the light output unit for the left eye 50L is off, only the luminance characteristic of the light signal for the right eye 56R can be accurately measured. More specifically, in the first measurement, a first luminance value is measured while outputting the light signal for the right eye 56R for displaying a black image as a reference image, a second luminance value is measured while outputting the light signal for the right eye 56R for displaying a white image as a reference image, and a first representative luminance value is extracted from the luminance range of the first luminance value to the second luminance value. The result measured by the luminance meter 59 is output to the adjustment unit 51 and is stored in a memory of the adjustment unit 51, for example. Then, the average value of the first and second luminance values is calculated by the adjustment unit 51, and this average value is set as a (first) representative luminance value of the light signal for the right eye 56R. Then, the representative luminance value is also stored in the adjustment unit 51.

(2. Acquisition of a Representative Luminance Value of a Light Signal for the Left Eye)

Next, second measurement for measuring the luminance of a light signal for the left eye is performed. As shown in FIG. 5C, for example, the second measurement is performed by measuring the luminance of the light signal for the left eye 56L using the luminance meter 59 in a state where a reference image is displayed on the light output unit for the left eye 50L and the light output unit for the right eye 50R is not driven (light output is off). Thus, if the second measurement is performed in a state where the light output of the light output unit for the right eye 50R is off, only the luminance characteristic of the light signal for the left eye 56L can be accurately measured. More specifically, in the second measurement, a third luminance value is measured while outputting the light signal for the left eye 56L for displaying a black image as a reference image, a fourth luminance value is measured while outputting the light signal for the left eye 56L for displaying a white image as a reference image, and a second representative luminance value is extracted from the luminance range of the third luminance value to the fourth luminance value. The result measured by the luminance meter 59 is output to the adjustment unit 51 and is stored in a memory of the adjustment unit 51, for example. Then, the average value of the third and fourth luminance values is calculated by the adjustment unit 51, and this average value is set as a (second) representative luminance value of the light signal for the left eye 56L. Then, the representative luminance value is also stored in the adjustment unit 51.

As described above, the first and second representative luminance values corresponding to each other are acquired by the first and second measurements, respectively.

(3. Luminance Adjustment Based on the Representative Luminance Value)

Then, the adjustment unit 51 adjusts outputs of the light output unit for the right eye 50R and the light output unit for the left eye 50L in the lenticular display system 9B such that a difference between the representative luminance value of the light signal for the right eye 56R and the representative luminance value of the light signal for the left eye 56L acquired as described above falls within a predetermined range. Specifically, the adjustment unit 51 compares the representative luminance value of the light signal for the right eye 56R with the representative luminance value of the light signal for the left eye 56L, and adjusts the output of the light output unit for the right eye 50R and/or the light output unit for the left eye 50L such that the difference falls within a predetermined range while aligning the larger one with the smaller one. For example, the luminance can be adjusted by performing integral multiples of the output of the light output unit with a larger representative luminance value. Moreover, in the present embodiment, the predetermined range is preferably set to be 30% or less of the smaller representative luminance value. If the difference is 40% or more of the smaller representative luminance value, distortion occurs according to the Pulfrich effect. As a result, a sense of depth becomes unstable.

If the luminance adjustment ends through the above procedure, the observer inputs to the input unit 7 an instruction to display a stereoscopic image of the breast M. In response to the display instruction, two radiological image signals of the subject are read from the radiological image storage unit 8b by the display controller 8c. Then, the display controller 8c performs stereoscopic display of a stereoscopic image, which includes a radiological image for the right eye and a radiological image for the left eye generated based on the two radiological image signals, on the stereoscopic display 9. Since the observer can perform stereoscopic viewing based on the luminance-adjusted light signal, satisfactory stereoscopic viewing can be performed.

### Third Embodiment

An adjustment method of a stereoscopic display, an adjustment device used therefore, a stereoscopic image display method, and a display device used therefore according to a third embodiment of the present invention will be described. In addition, the present embodiment is different from the first embodiment in that the stereoscopic display 9 shown in FIG. 1 is a projection type display system. Accordingly, details of the same components as in the first embodiment will be omitted if not necessary.

In the present embodiment, the case where a projection type display system 9C is adopted as the stereoscopic display 9 will be specifically described.

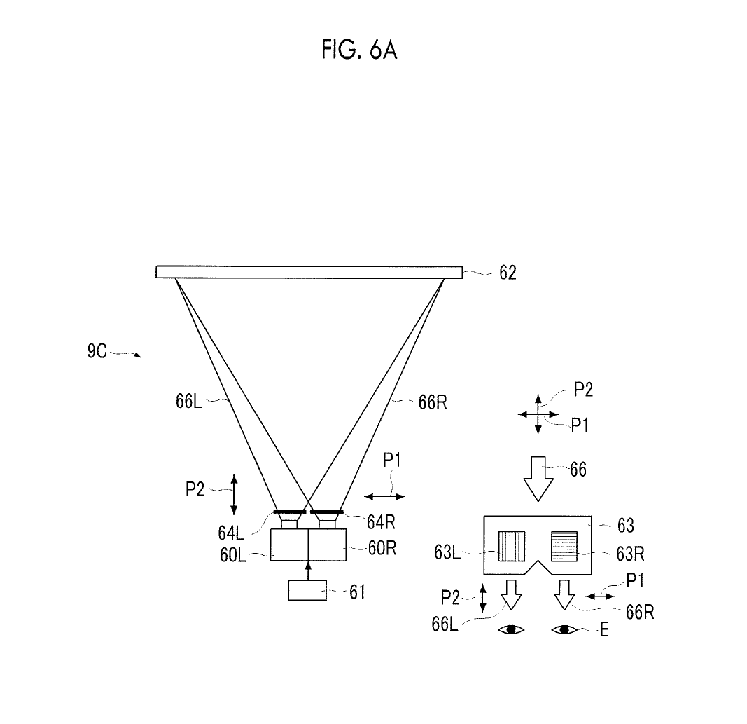

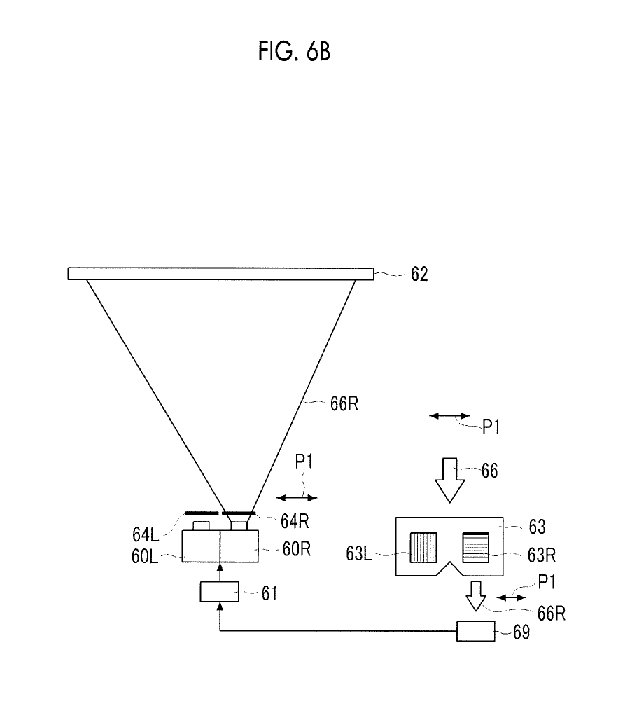

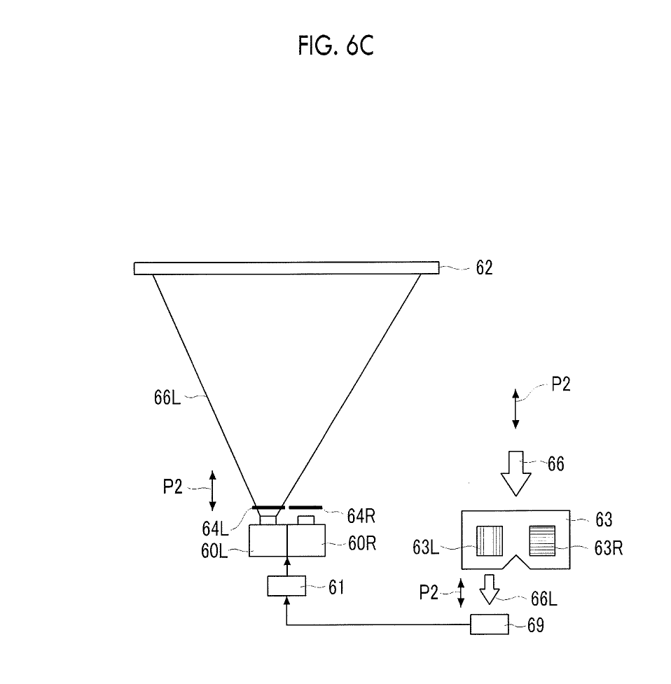

FIG. 6A is a schematic view showing the configuration of the projection type display system 9C of the present embodiment. The projection type display system 9C includes a light output unit for the right eye 60R which outputs a light signal for the right eye 66R for displaying an image for the right eye, a light output unit for the left eye 60L which outputs a light signal for the left eye 66L for displaying an image for the left eye, an adjustment unit 61 that adjusts outputs of the light output units, a screen 62 onto which the light signal for the right eye 66R and the light signal for the left eye 66L are projected, a polarizing filter 64R which polarizes the light signal for the right eye 66R, a polarizing filter 64L which polarizes the light signal for the left eye 66L, polarizing glasses 63, and a luminance meter 69. The adjustment unit 61 and the luminance meter 69 form an adjustment device of the stereoscopic display in the present embodiment.

The light output unit for the right eye 60R and the light output unit for the left eye 60L are light output units whose outputs can be separately controlled. The light output unit for the right eye 60R and the light output unit for the left eye 60L are disposed such that the light signal for the right eye 66R and the light signal for the left eye 66L are projected onto the screen 62.

The adjustment unit 61 functions as adjustment means in the present invention, and controls backlights of the light output unit for the right eye 60R and the light output unit for the left eye 60L to adjust the outputs, for example. For example, the adjustment unit 61 includes a memory for storing a measurement result of the luminance meter 69 which will be described later.

The polarizing filters 64R and 64L are disposed on the front surfaces of the light output unit for the right eye 60R and the light output unit for the left eye 60L in order to polarize the light signal for the right eye 66R, and the light signal for the left eye 66L, respectively. In this case, the light signal for the right eye 66R output from the light output unit for the right eye 60R is polarized in the horizontal direction P1. On the other hand, the light signal for the left eye 66L output from the light output unit for the left eye 60L is polarized in the vertical direction P2.

In the case of front projection, a silver screen with metal powder applied thereon is used as the screen 62 in order to maintain the projection plane of polarization. A mixed signal 66 is generated by projecting the light signal for the right eye 66R and the light signal for the left eye 66L on the screen.

The polarizing glasses 63 include a polarizing filter 63R, which allows the light signal for the right eye 66R polarized in the horizontal direction P1 to be transmitted therethrough, and a polarizing filter 63L, which allows the light signal for the left eye 66L polarized in the vertical direction P2 to be transmitted therethrough. The observer E observes the mixed signal 66 through the polarizing glasses 63. In this case, since the polarizing filter 63R allows only the light signal for the right eye 66R polarized in the horizontal direction P1 to be transmitted therethrough and the polarizing filter 63L allows only the light signal for the left eye 66L polarized in the vertical direction P2 to be transmitted therethrough, only the light signal for the right eye 66R is received by the right eye of the observer and only the light signal for the left eye 66L is received by the left eye. As a result, since the observer E can recognize two images with parallax by the respective left and right eyes, stereoscopic viewing can be realized.

The luminance meter 69 functions as measurement means in the present invention, and measures the luminance of a light signal output from the light output unit. When measuring the luminance, the luminance meter 69 is usually disposed so as to detect a light signal transmitted through the polarizing glasses 63, that is, so as to detect a light signal output from the projection type display system 9C. However, the arrangement of the luminance meter 69 is not limited to this for the same reason as in the first embodiment.

Specifically, such luminance adjustment in the present embodiment is performed through the following procedure using the adjustment device of the stereoscopic display according to the present embodiment.

(1. Acquisition of a Representative Luminance Value of a Light Signal for the Right Eye)

First, first measurement for measuring the luminance of a light signal for the right eye is performed. As shown in FIG. 6B, for example, the first measurement is performed by measuring the luminance of the light signal for the right eye 66R using the luminance meter 69 in a state where a reference image is displayed on the light output unit for the right eye 60R and the light output unit for the left eye 60L is not driven (light output is off). Thus, if the first measurement is performed in a state where the light output of the light output unit for the left eye 60L is off, only the luminance characteristic of the light signal for the right eye 66R can be accurately measured. More specifically, in the first measurement, a first luminance value is measured while outputting the light signal for the right eye 66R for displaying a black image as a reference image, a second luminance value is measured while outputting the light signal for the right eye 66R for displaying a white image as a reference image, and a first representative luminance value is extracted from the luminance range of the first luminance value to the second luminance value. The result measured by the luminance meter 69 is output to the adjustment unit 61 and is stored in a memory of the adjustment unit 61, for example. Then, the average value of the first and second luminance values is calculated by the adjustment unit 61, and this average value is set as a (first) representative luminance value of the light signal for the right eye 66R. Then, the representative luminance value is also stored in the adjustment unit 61.

(2. Acquisition of a Representative Luminance Value of a Light Signal for the Left Eye)

Next, second measurement for measuring the luminance of a light signal for the left eye is performed. As shown in FIG. 6C, for example, the second measurement is performed by measuring the luminance of the light signal for the left eye 66L using the luminance meter 69 in a state where a reference image is displayed on the light output unit for the left eye 60L and the light output unit for the right eye 60R is not driven (light output is off). Thus, if the second measurement is performed in a state where the light output of the light output unit for the right eye 60R is off, only the luminance characteristic of the light signal for the left eye 66L can be accurately measured. More specifically, in the second measurement, a third luminance value is measured while outputting the light signal for the left eye 66L for displaying a black image as a reference image, a fourth luminance value is measured while outputting the light signal for the left eye 66L for displaying a white image as a reference image, and a second representative luminance value is extracted from the luminance range of the third luminance value to the fourth luminance value. The result measured by the luminance meter 69 is output to the adjustment unit 61 and is stored in a memory of the adjustment unit 61, for example. Then, the average value of the third and fourth luminance values is calculated by the adjustment unit 61, and this average value is set as a (second) representative luminance value of the light signal for the left eye 66L. Then, the representative luminance value is also stored in the adjustment unit 61.

As described above, the first and second representative luminance values corresponding to each other are acquired by the first and second measurements, respectively.

(3. Luminance Adjustment Based on the Representative Luminance Value)

Then, the adjustment unit 61 adjusts outputs of the light output unit for the right eye 60R and the light output unit for the left eye 60L in the projection type display system 9C such that a difference between the representative luminance value of the light signal for the right eye 66R and the representative luminance value of the light signal for the left eye 66L acquired as described above falls within a predetermined range. Specifically, the adjustment unit 61 compares the representative luminance value of the light signal for the right eye 66R with the representative luminance value of the light signal for the left eye 66L, and adjusts the output of the light output unit for the right eye 60R and/or the light output unit for the left eye 60L such that the difference falls within a predetermined range while aligning the larger one with the smaller one. For example, the luminance can be adjusted by performing integral multiples of the output of the light output unit with a larger representative luminance value. Moreover, in the present embodiment, the predetermined range is preferably set to be 30% or less of the smaller representative luminance value. If the difference is 40% or more of the smaller representative luminance value, distortion occurs according to the Pulfrich effect. As a result, a sense of depth becomes unstable.

If the luminance adjustment ends through the above procedure, the observer inputs to the input unit 7 an instruction to display a stereoscopic image of the breast M. In response to the display instruction, two radiological image signals of the subject are read from the radiological image storage unit 8b by the display controller 8c. Then, the display controller 8c performs stereoscopic display of a stereoscopic image, which includes a radiological image for the right eye and a radiological image for the left eye generated based on the two radiological image signals, on the stereoscopic display 9. Since the observer can perform stereoscopic viewing based on the luminance-adjusted light signal, satisfactory stereoscopic viewing can be performed.

<Design Change>

The adjustment method of a stereoscopic display, the adjustment device used therefore, the stereoscopic image display method, and the display device used therefore described in the first to third embodiments may also be applied to stereoscopic displays, such as a parallax barrier type stereoscopic display or a head mounted display.

In each of the above embodiments, adjusting the output of the light output unit for the right eye and/or the light output unit for the left eye has been described. More specifically, the data stored in a LUT (Look Up Table) provided in the light output unit for the right eye and/or the light output unit for the left eye may be adjusted, or the image data input to the light output unit for the right eye and/or the light output unit for the left eye may be adjusted.

In each of the above embodiments of the present invention, the case where the stereoscopic image display method and the stereoscopic image display device are applied to the breast image radiographing display system has been described. However, the present invention is not limited to this. For example, applications to other medical diagnostic apparatuses, digital cameras, display devices, and the like using the stereoscopic image display method may also be made.

What is claimed is:

1. An adjustment method of a stereoscopic display which stereoscopically display images for right eye and left eye having parallax with respect to each other, the display having a light output unit for the right eye which outputs a light signal for the right eye to display the image for the right eye, and a light output unit for the left eye which outputs a light signal for the left eye to display the image for the left eye, wherein the method comprising steps of;
performing first measurement for measuring the luminance of the light signal for the right eye;
performing second measurement for measuring the luminance of the light signal for the left eye;
acquiring first and second representative luminance values corresponding to each other by the first and second measurements, respectively; and
adjusting an output of the light output unit for the right eye and/or the light output unit for the left eye such that a difference between the first and second representative luminance values falls within a predetermined range.

2. The adjustment method of a stereoscopic display according to claim 1,
wherein the first measurement is performed while outputting the one or more light signals for the right eye which displays one or more reference images respectively, and
the second measurement is performed while outputting the one or more light signals for the left eye which displays the one or more reference images respectively.

3. The adjustment method of a stereoscopic display according to claim 2,
wherein in the first measurement, a first luminance value is measured while outputting the light signal for the right eye for displaying a black image as the reference image, and a second luminance value is measured while outputting the light signal for the right eye for displaying a white image as the reference image,
the first representative luminance value is set in a range of the first luminance value to the second luminance value,
in the second measurement, a third luminance value is measured while outputting the light signal for the left eye for displaying a black image as the reference image, and a fourth luminance value is measured while outputting the light signal for the left eye for displaying a white image as the reference image, and
the second representative luminance value is set in a range of the third luminance value to the fourth luminance value.

4. The adjustment method of a stereoscopic display according to claim 3,
wherein the first luminance value, the second luminance value, or an average value of the first and second luminance values is set as the first representative luminance value, and
the third luminance value, the fourth luminance value, or an average value of the third and fourth luminance values is set as the second representative luminance value.

5. The adjustment method of a stereoscopic display according to claim 2,
wherein an average value of the luminance of the light signal for the right eye in a predetermined period for which the one or more reference images are displayed is extracted as the first representative luminance value, and
an average value of the luminance of the light signal for the left eye in a predetermined period for which the one or more reference images are displayed is extracted as the second representative luminance value.

6. The adjustment method of a stereoscopic display according to claim 1,
wherein the first measurement is performed in a state where the light signal for the left eye is not output, and the second measurement is performed in a state where the light signal for the right eye is not output.

7. The adjustment method of a stereoscopic display according to claim 2,
wherein the first measurement is performed in a state where the light signal for the left eye is not output, and the second measurement is performed in a state where the light signal for the right eye is not output.

8. The adjustment method of a stereoscopic display according to claim 3,
wherein the first measurement is performed in a state where the light signal for the left eye is not output, and the second measurement is performed in a state where the light signal for the right eye is not output.

9. The adjustment method of a stereoscopic display according to claim 4,
wherein the first measurement is performed in a state where the light signal for the left eye is not output, and the second measurement is performed in a state where the light signal for the right eye is not output.

10. The adjustment method of a stereoscopic display according to claim 5,
wherein the first measurement is performed in a state where the light signal for the left eye is not output, and the second measurement is performed in a state where the light signal for the right eye is not output.

11. The adjustment method of a stereoscopic display according to claim 1,
wherein the stereoscopic display is a display using a polarizing filter method, a lenticular display, or a head mounted display.

12. The adjustment method of a stereoscopic display according to claim 2,
wherein the stereoscopic display is a display using a polarizing filter method, a lenticular display, or a head mounted display.

13. The adjustment method of a stereoscopic display according to claim 3,
wherein the stereoscopic display is a display using a polarizing filter method, a lenticular display, or a head mounted display.

14. An adjustment device of a stereoscopic display which stereoscopically display images for right eye and left eye having parallax with respect to each other, the display having a light output unit for the right eye which outputs a light signal for the right eye to display the image for the right eye, and a light output unit for the left eye which outputs a light signal for the left eye to display the image for the left eye, wherein the adjustment device comprising:
measurement means for performing first measurement for measuring the luminance of the light signal for the right eye, performing second measurement for measuring the luminance of the light signal for the left eye, and acquiring first and second representative luminance values corresponding to each other by the first and second measurements; respectively; and
adjustment means for adjusting an output of the light output unit for the right eye and/or the light output unit for the left eye such that a difference between the first representative luminance value acquired by the first measurement and the second representative luminance value acquired by the second measurement falls within a predetermined range.

15. The adjustment device of a stereoscopic display according to claim 14,
wherein the measurement means performs the first measurement while outputting the light signal for the right eye which displays one or more reference images respectively, and performs the second measurement while outputting the light signal for the left eye which displays the one or more reference images respectively.

16. The adjustment device of a stereoscopic display according to claim 15,
wherein in the first measurement, the measurement means measures a first luminance value while outputting the light signal for the right eye for displaying a black image as the reference image and measures a second luminance value while outputting the light signal for the right eye for displaying a white image as the reference image,
the measurement means sets the first representative luminance value in a range of the first luminance value to the second luminance value,
in the second measurement, the measurement means measures a third luminance value while outputting the light signal for the left eye for displaying a black image as the reference image and measures a fourth luminance value while outputting the light signal for the left eye for displaying a white image as the reference image, and
the measurement means sets the second representative luminance value in a range of the third luminance value to the fourth luminance value.

17. The adjustment device of a stereoscopic display according to claim 15,
wherein the measurement means extracts, as the first representative luminance value, an average value of the luminance of the light signal for the right eye in a predetermined period for which the one or more reference images are displayed and extracts, as the second representative luminance value, an average value of the luminance of the light signal for the left eye in a predetermined period for which the one or more reference images are displayed.

18. A stereoscopic image display method of displaying a stereoscopic image including an image for a right eye and an image for a left eye with parallax for stereoscopic viewing using a stereoscopic display, the stereoscopic image display method comprising:
adjusting the stereoscopic display using the adjustment method of a stereoscopic display according to claim 1; and
displaying the stereoscopic image on the stereoscopic display for stereoscopic viewing.

19. A stereoscopic image display method of displaying a stereoscopic image including an image for a right eye and an image for a left eye with parallax for stereoscopic viewing using a stereoscopic display, the stereoscopic image display method comprising:
adjusting the stereoscopic display using the adjustment method of a stereoscopic display according to claim 2; and
displaying the stereoscopic image on the stereoscopic display for stereoscopic viewing.

20. A stereoscopic image display device comprising:
a stereoscopic display;
a display controller which displays a stereoscopic image, which includes an image for a right eye and an image for a left eye with parallax, on the stereoscopic display for stereoscopic viewing; and
the adjustment device of a stereoscopic display according to claim 14 which adjusts the stereoscopic display.
